(19) United States
(12) Patent Application Publication
(10) Pub. No.: US 2017/0305737 A1
(43) Pub. Date: Oct. 26, 2017

(54) DIRECT FILL FUELING SYSTEMS AND DEVICES

(71) Applicant: Ameri-Kart, Akron, OH (US)

(72) Inventors: Justin Andrew Hines, Goshen, OH (US); Eric Brian VanDiepenbos, New Paris, ID (US)

(73) Assignee: Ameri-Kart, Akron, OH (US)

(21) Appl. No.: 15/492,328

(22) Filed: Apr. 20, 2017

Related U.S. Application Data
(60) Provisional application No. 62/325,505, filed on Apr. 21, 2016.

(51) Int. Cl. B67D 7/54; B67D 7/04

(52) U.S. Cl. CPC B67D 7/54; B67D 7/0476

(57) ABSTRACT

This disclosure relates to direct fill fueling systems and devices for filling and venting a tank. A direct fill fueling system can include the tank, a fill neck for receiving a nozzle, and a nozzle bounding member for setting an insertion depth of the nozzle received by the fill neck. The nozzle bounding member can include a stop that can be aligned with the opening of the fill neck and configured to obstruct the motion of the nozzle, when the nozzle is inserted into the fill neck. The nozzle bounding member can be provided as a tubular insert. The tubular insert can include the stop. The stop can include one or more locating slats positioned at an end of the tubular insert.

### CROSS-REFERENCED TO RELATED APPLICATION

This application claims the benefit of U.S. Provisional Application No. 62/325,505, filed on Apr. 21, 2016, entitled “DIRECT FILL FUELING SYSTEMS AND DEVICES”, the contents of which are incorporated herein by reference.

### TECHNICAL FIELD

The present disclosure generally relates to systems and devices for directly filling a tank. More specifically, this disclosure relates to direct fill fueling systems and devices.

### BACKGROUND

Recently, the marine industry has been mandated to conform to Environmental Protection Agency (EPA) regulations aimed at reducing the release of hydrocarbons into the atmosphere from marine gasoline fuel systems. The efforts to comply with such standards has increased the complexity of fuel system components. The increased complexity has increased component and labor costs. With the marine industry pushing for a direct fill fuel system to reduce cost and system complexity, some manufacturers of diurnal systems and fuel tanks have responded by adapting remote fill systems to a direct fill application. In some cases, remote deck fill automatic shutoff devices have been modified to be mounted directly to the fuel tank. However, such systems have increased the cost and complexity of direct fill fuel systems.

Accordingly, a need exists for alternative systems and devices for directly filling a tank.

### SUMMARY

In one example, a system can include a tank and a nozzle bounding member. The tank can include a wall that can bound an interior volume of the tank and a fill neck that can extend away from the wall and form an opening of the tank. The nozzle bounding member can be coupled to the tank. The nozzle bounding member can include a stop aligned with the opening of the fill neck and that can be configured to obstruct the motion of a nozzle, when the nozzle is inserted into the fill neck of the tank.

In another example, a system can include a tank and a tubular insert. The tank can include a wall that can bound an interior volume of the tank and a fill neck that can extend away from the wall and form an opening of the tank. The tubular insert can be provided in the fill neck. The tubular insert can form a passageway that can extend from a first end of the tubular insert to a second end of the tubular insert. The second end of the tubular insert can be positioned within the interior volume of the tank and offset from the wall. The tubular insert can include one or more locating slats that can be positioned at the second end of the tubular insert, and an orifice that can be formed through the tubular insert. The orifice can be positioned between the one or more locating slats and the wall of the tank. The one or more slats can be configured to obstruct a motion of a nozzle, when the nozzle is inserted into the fill neck.

In even further example, a system can include a tank and a tubular insert. The tank can include a wall that can bound an interior volume of the tank and a fill neck that can extend away from the wall. The fill neck can include a first portion that can form an opening of the tank and a second portion adjacent to the wall of the tank. The second portion can have a larger cross section area than the first portion. The tubular insert can be coupled to the first portion of the fill neck. The tubular insert can form a passageway that can extend from a first end of the tubular insert to a second end of the tubular insert. The second end of the tubular insert can be positioned within the interior volume of the tank and offset from the wall. The tubular insert can include one or more locating slats that can be positioned at the second end of the tubular insert. The one or more slats can be configured to obstruct a motion of a nozzle, when the nozzle is inserted into the fill neck.

### BRIEF DESCRIPTION OF THE DRAWINGS

FIG. 1 illustrates an example of a cross sectional view of a direct fill system.

FIG. 2 illustrates an example of a cross sectional view of a fill neck.

FIG. 3 illustrates an example of a cross sectional view of a direct fill system.

FIGS. 4 and 5 illustrate an example of a tubular insert.

FIG. 6 illustrates an example of a cross sectional view of a direct fill system.

FIG. 7 illustrates an example of an enlarged view of the direct fill system as shown in FIG. 6.

### DETAILED DESCRIPTION

The present disclosure relates to direct fill fueling systems and devices for filling and venting a stank. A direct filling system can include a storage tank for storing fluids, a fill neck that for receiving a nozzle, and a nozzle bounding member for setting an insertion depth of the nozzle received by the fill neck. The term phrase “direct fill”, as used herein, can mean that an interior volume of a container can be filled directly by some dispenser with a fluid. Thus, a direct fill fuel tank can allow fuel to be pumped directly into the fuel tank without fill and vent hoses.

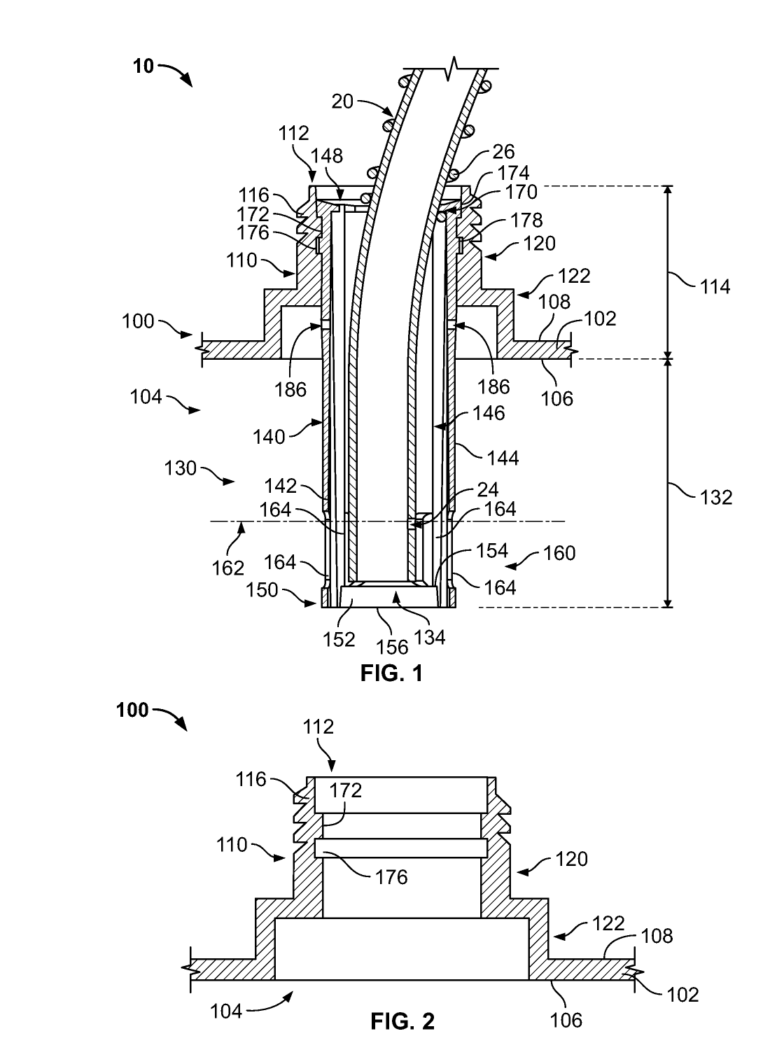

FIG. 1 illustrates an example of a cross sectional view of a direct fill system. The direct fill system 10 can include a storage tank 100 for storing fluid such as, but not limited to, gasoline, marine gasoline, diesel fuel, or the like. The storage tank 100 can be a type of vessel that can be filled directly with an automatic shutoff nozzle, non-automatic shutoff nozzle, a jerry can, or the like. The term “fluid” as used herein can mean a substance, such as a liquid or a gas, that is capable of flowing and changing shape at a steady rate in response to a force tending to change its shape.

The storage tank 100 can be formed from any material that has stabilizing properties in a presence (or exposure) to the fluid. In one example, the storage tank 100 can be formed from plastic materials such as, but not limited to, thermoplastics, polyethylene, cross-link polyethylene, nylon (e.g., Zytel), or the like. The storage tank 100 can be formed using a molding process (e.g., roto-molding, injection molding, or blow molding). In an alternative example, the storage tank 100 can be formed from metallic materials such as, but not limited to, aluminum, stainless steel, or the like. The storage tank 100 can include a wall 102 that bounds an interior volume 104 of the storage tank 100. The wall 102 can be positioned between the interior volume 104 and the atmosphere surrounding the storage tank 100. Specifically, the wall 102 can include an interior surface 106 configured to delimit the interior volume 104 and an exterior surface 108 that is exposed to the atmosphere. A fill level indicator can be formed (e.g., molded) or marked on the storage tank 100. For example, fluid contained in the interior volume 104 of the storage tank can be at least partially visible via the fill level indicator, through the wall 102 of the storage tank 100, or both.

Referring collectively to FIGS. 1 and 2, the storage tank 100 can include a fill neck 110 that can be configured to permit the direct filling of the storage tank 100 and venting of the storage tank 100. For example, the fill neck 110 can define a flow path that permits fluid to travel from the atmosphere to the interior volume 104 of the storage tank 100. In one example, the fill neck 110 can be molded and machined with additional features (e.g., drilled, threaded, etc.). Alternatively or additionally, the fill neck 110 can be formed by joining or fastening components together. The fill neck 110 can extend away from the wall 102 and can form an opening 112 in the storage tank 100. Thus, the opening 112 can be offset from the interior surface 106 of the wall 102 by the fill offset distance 114. The opening 112 can be configured to accept a fuel nozzle 20 such as, for example, an American Society for Testing Materials (ASTM) automotive fuel nozzle, or the like.

Referring collectively to FIGS. 1-3, the fill neck 110 can include a cap retention feature 116 for engaging with a cap 118 to substantially seal the opening 112 of the fill neck 110. The cap retention feature 116 can include threads formed in the exterior surface 108 of the storage tank 100 at a position adjacent to the opening 112 of the fill neck. For example, the cap retention feature 116 can include Kelch threads for mating with a cap 118 that can include corresponding Kelch threads. Alternatively or additionally, the cap retention feature 116 can include any locking or fastening feature suitable to maintain a substantially sealed opening 112 when subjected to expansion pressure of fluid contained by the storage tank 110 such as, for example, threads, a bayonet connection, a latch, a hinge, or the like.

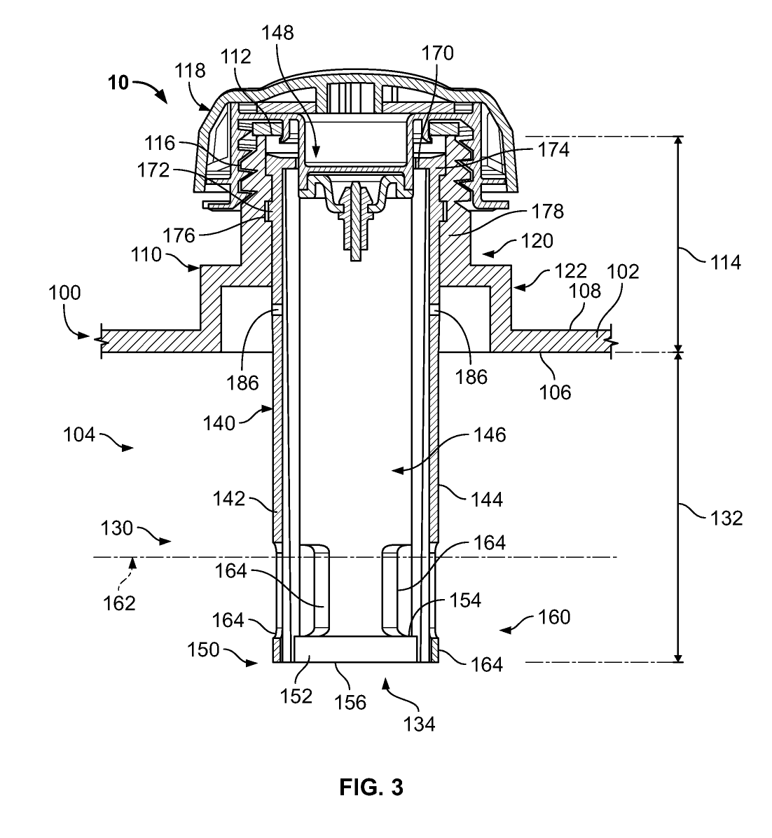

In one example, the system 10 can include the cap 118. The cap 118 can be configured to substantially seal the interior volume 104 of the storage tank 100 the atmosphere, e.g., the storage tank 100 can be sealed between fillings. The cap 118 can be configured to limit permeation, e.g., the cap 118 can be provided without vents. Alternatively or additionally, the cap 118 can include vents that can allow fluid transfer between the interior volume 104 of the storage tank 100 and the atmosphere. The cap 118 can be tethered to or form a hinged connection with the storage tank 100 to prevent loss. It is noted that, while FIG. 3 depicts the cap 118 for sealing the storage tank 100, any sealing device suitable to limit fluid communication between the interior volume 104 of the storage tank 100 and the atmosphere can be used such as, but not limited to, a self-sealing system positioned at the opening 112 of the fill neck 110 or any other position within the storage tank 100.

The fill neck 110 can include a first portion 120 and a second portion 122. The opening 112 can be formed in the first portion 120 of the fill neck 110, and the second portion 122 of the fill neck 110 can be positioned between the first portion 120 of the fill neck 110 and the wall 102. The first portion 120 of the fill neck 110 can define a cross sectional area along the interior surface 106 that is smaller than a cross sectional area along the interior surface 106 defined by the second portion 122 of the fill neck 110. In examples where the first portion 120 and the second portion 122 of the fill neck 110 define substantially cylindrical tubular bodies, the substantially circular area of the first portion 120 can be smaller than the substantially circular area of the second portion 122. Optionally, the fill neck 110 can include an insert or gauge that is visible through the fill neck 110 and that can be configured to indicate the amount of fluid in the storage tank 100. It is noted that, while the fill neck 110 is depicted in FIGS. 1-3 as having a substantially circular cross section, the fill neck 110 can be formed using any shape suitable for defining a fluid flow path that can accept the nozzle 20 such as, but not limited to, substantially oval shaped cross section, polygonal (square, rectangle, etc.) shaped cross section, or the like.

Referring collectively to FIGS. 1 and 3, the system 10 can include a nozzle bounding member 130 that can be coupled to the storage tank 100 and configured to set an insertion depth 132 of the nozzle 20 with respect to the storage tank 100. Specifically, the nozzle bounding member 130 can include a stop 134 that is offset from the interior surface 106 of the wall 102 by the insertion depth 132. The nozzle bounding member 130 can be formed from plastic materials or metallic materials, as described herein with respect to the storage tank 100. Optionally, the nozzle bounding member 130 can be formed from the same material as the storage tank 100. The stop 134 can be aligned with the opening 112 of the of the fill neck 110 and configured to obstruct the motion of the nozzle 20, when the nozzle 20 is inserted into the fill neck 110. Optionally, the insertion depth 132 can be larger than the fill offset distance 114. Such a configuration can provide a suitable amount of ullage space in the interior volume 104 of the storage tank 100.

The nozzle bounding member 130 can be formed into any structural member suitable to obstruct the motion of the nozzle 20. In one example, the nozzle bounding member 130 can be suspended from the wall 102 at a position above the stop 134. In another example, the nozzle bounding member 130 can project from the wall at a position at or below the stop 134. In an even further example, the nozzle bounding member 130 can be integral with the fill neck 110. For instance, the nozzle bounding member 130 can be molded, machined, or joined (e.g., welded or adhered) to the fill neck 110 during manufacture of the storage tank 100. In other examples, the nozzle bounding member 130 can be provided as an insert that is joined to the fill neck 100 or engaged with the fill neck 100 after manufacture of the storage tank 100.

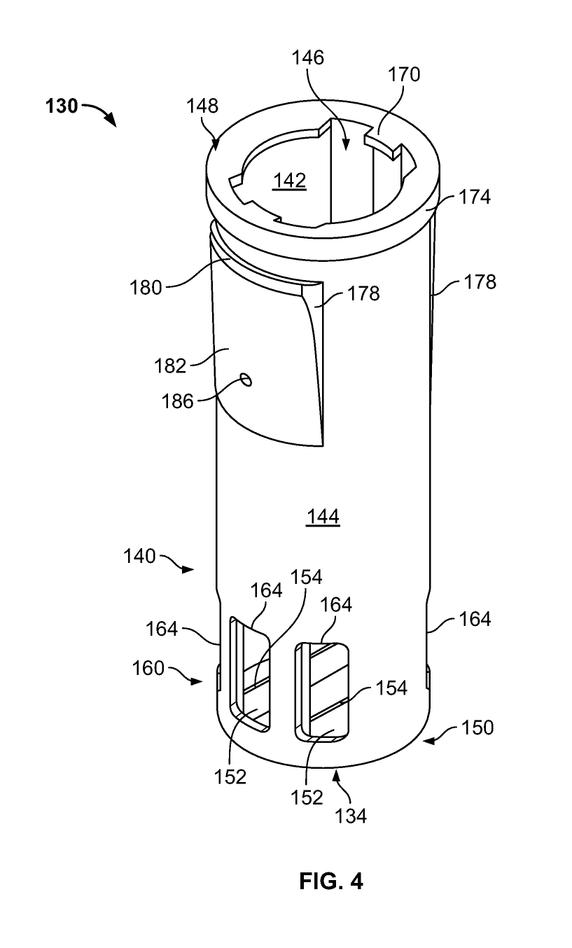

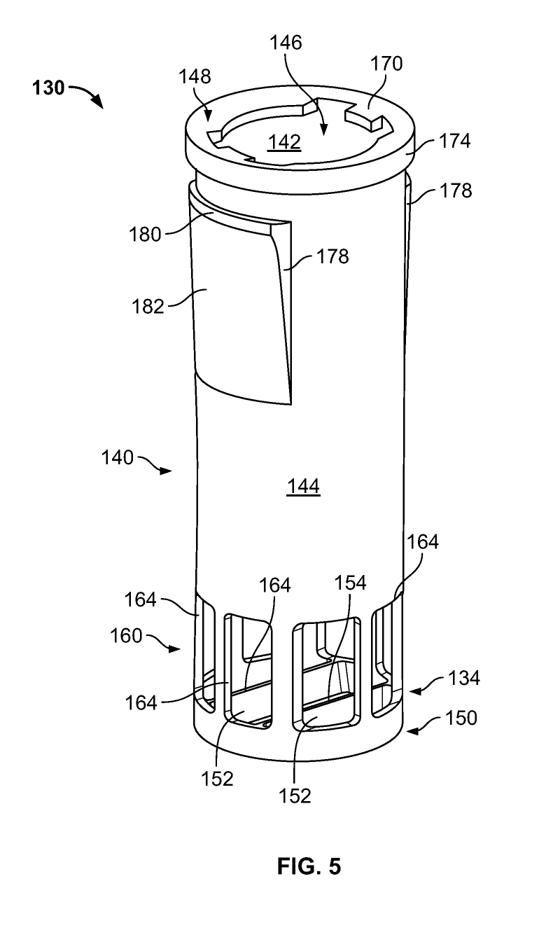

Referring collectively to FIGS. 1 and 3-6, the nozzle bounding member 130 can be provided as a tubular insert 140. The tubular insert 140 can include an exterior surface 142 and an interior surface 144 that can define a passageway 146. The passageway 146 can extend from a first end 148 of the tubular insert 140 to a second end 150 of the tubular insert 140. It is noted that, while the tubular insert 140 is depicted as being substantially cylindrical, the tubular insert 140 can be formed in any desired shape. Moreover, the interior surface 144 can define any desired cross sectional shape for the passageway 146 suitable for receiving the nozzle 20 such as, but not limited to, substantially circular shaped cross section, substantially oval shaped cross section, polygonal (square, rectangle, etc.) shaped cross section, or the like.

In one example, the stop 134 can be positioned at the second end 150 the of the tubular insert 140. The stop 134 can be configured to only partially obstruct the second end 150 of the tubular insert 140, e.g., fluid can be permitted to travel between the passageway 146 and the interior 104 of the storage tank 100. The stop 134 can include one or more locating slats 152 that can be configured to limit the depth that the nozzle 20 can be inserted into the storage tank 100. Specifically, the one or more locating slats 152 can be configured to extend from the interior surface 142 of the tubular insert 140 and into the passageway 146. The one or more locating slats 152 can have anybody suitable to obstruct the motion of the dispensing end 22 of the nozzle 20. For example, the one or more locating slats 152 can be at least large enough to reduce the cross sectional of the passageway 146 at the insertion depth 132 to an area smaller than the dispensing end 22 of the nozzle 20.

In an example, the one or more locating slats 152 can be a substantially rigid body that spans the passageway 146 of the tubular body 140, e.g., the one or more locating slats 152 can extend from opposing sides of the interior surface 142. The one or more locating slats 152 can include a contact surface 154 (e.g., an upper edge) that can be positioned at the at the insertion depth 132 and a free surface 156 that can be positioned further away from the first end 148 of the tubular body 140. In examples where the stop 134 includes more than one locating slats 152, each locating slat 152 can be spaced from one another to provide a gap for the flow of fluid through the locating slats 152.

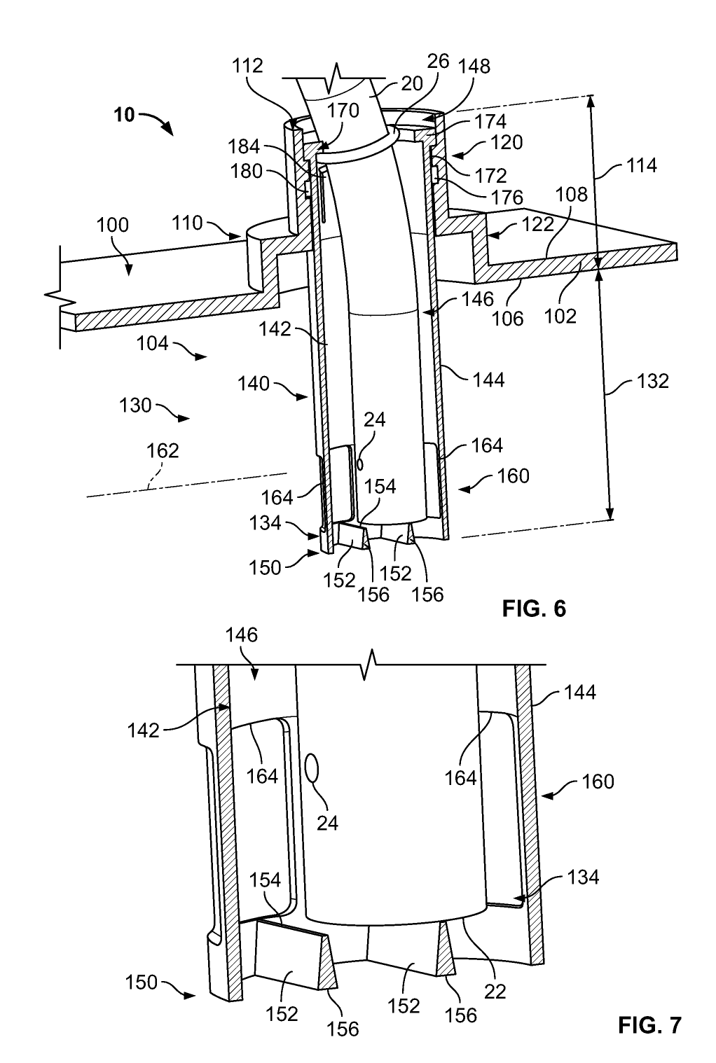

Referring collectively to FIGS. 6 and 7, each of the locating slats 152 can include a substantially trapezoidal shaped cross section, e.g., the cross sectional length of the contact surface 154 can be shorter than the cross sectional length of the free surface 156. It is noted that, while the cross sectional shape of the locating slat 152 is depicted as being substantially trapezoidal in FIGS. 6 and 7, the cross sectional shape of the locating slat 152 can define any desired cross sectional shape suitable for permitting fluid to flow from the nozzle 20. The one or more of the locating slats 152 can be aligned substantially parallel with respect to the passageway 146. Alternatively or additionally, one or more of the locating slats 152 can be canted or angled with respect to the passageway 146, e.g., the locating slats 152 can be configured to change the direction of fluid flowing through the stop 134.

Referring collectively to FIGS. 1-6, the tubular insert 140 can include a cage 160 that can be configured to expose an aspirator 24 of the nozzle 20 to the interior volume 104 of the storage tank 100. For example, the cage 160 can allow fluid to flow laterally through a thickness of the tubular insert when the fluid level meets or exceeds a fill amount 162 within the storage tank 100. The cage 160 can be positioned between the first end 148 and the second end 150. The cage 160 can be positioned closer to the second end 150 than the first end 148 of the tubular insert 140. In one example, the cage 160 can define one or more orifices 164 formed through the thickness of the tubular insert 140. Each orifice 164 can be positioned in the tubular insert 140 between the one or more locating slats 152 and the wall 102 of the storage tank 100. It is noted that, while the orifices 164 are depicted as being substantially rectangular in FIGS. 1 and 3-7, the orifices can be formed in any shape suitable for exposing the aspirator 24 of the nozzle 20 when the fluid level meets or exceeds a fill amount 162. For example, the cage 160 and the locating slats 152 can cooperate to permit the fluid level within the passageway 146 to be substantially equal to the fluid level surrounding the exterior surface 144 of the tubular insert 140.

The tubular insert 140 can be substantially open at the cage 160 such that a given percentage of the tubular insert 140 can be removed at the cage 160. For instance, the tubular 140 can be substantially open at the cage 160 such as, for example, at least about 5% of the tubular insert 140 can be removed at the cage 160 in one example, at least about 25% of the tubular insert 140 can be removed at the cage 160 in another example, at least about 50% of the tubular insert 140 can be removed at the cage 160 in an even further example, at least about 65% of the tubular insert 140 can be removed at the cage 160 in another example, or at least about 75% of the tubular insert 140 can be removed at the cage 160 in a further example.

In an alternative example, the tubular insert 140 can be provided without any orifices between the one or more locating slats 152 and the wall 102 of the storage tank 100. Accordingly, the aspirator 24 of the nozzle 20 can be subjected to increased amount splashing of dispensed fuel from the one or more locating slats 152. Additionally, the ullage space of the storage tank 100 can be pressurized deeper into the storage tank 100, which can be changed by adjusting the fill offset distance 114. Thus, in some examples, the insertion depth 132 can be smaller than the fill offset distance 114.

According to the examples described herein, the tubular insert 140 can include a nozzle retention flange 170 that can be configured to limit the motion of the nozzle 20, when the nozzle is inserted into the storage tank 100. The nozzle retention flange 170 can be positioned at the first end 148 of the tubular insert 140. The nozzle retention flange 170 can reduce the diameter of the passageway 146 at the first end 148. In one example, the nozzle retention flange 170 can include one or more tabs that interact with a retaining spring 26 of the nozzle 30 to limit a motion of the nozzle 20, when the nozzle 20 is received by the tubular insert 140. In an alternative example, the nozzle retention flange 170 can positioned on the fill neck 110 such as, but not limited to, the first portion 120 of the fill neck 110.

Additionally or alternatively, the tubular insert 140 can be configured to engage the fill neck 110 after manufacture of the storage tank 100. In some examples, the fill neck 110 and the tubular insert 140 can include engagement features configured to form an interference fit there between. As illustrated in FIGS. 1-6, the fill neck 110 can include engagement features that can be configured to correspond with the engagement features of the tubular insert 140. The engagement features of the fill neck 110 can include a rib 172 that can be formed with the interior surface 106 of the first portion 120 of the fill neck 110. The rib 172 can be shaped to interact with an outer flange 174 of the tubular insert 140. For example, the outer flange 174 can be positioned at the first end 148 of the tubular insert 140 and can extend radially outward with respect to the passageway 146. Accordingly, the outer flange 174 can contact the rib 172 and can resist movement of the tubular insert 140 towards the interior volume 104 of the storage tank 100. Alternatively or additionally, the engagement features of the fill neck 110 can include a recess 176 formed with the interior surface 106 of the first portion 120 of the fill neck 110. The recess 176 can be shaped to interact with a graduated detent 178 of the tubular insert 140.

Referring collectively to FIGS. 1-4, the graduated detent 178 can include a mating member 180 correspondingly shaped to the recess 176 of the fill neck 110 and a ramp portion 182 that gradually increases the cross sectional area of the exterior surface 144 of the tubular insert 140 as the ramp portion 180 extends towards the mating member 180 along the tubular insert 140. The ramp portion 182 can form a slope that can be configured to encourage sliding of the tubular insert 140 with respect to the fill neck 110. In one example, the ramp portion 182 can be substantially arcuate. Thus, the tubular insert 140 can be configured to urge into the fill neck 110 and slide along the first portion 120 of the fill neck 110 such that the recess 176 of the fill neck 110 can receive the mating member 180. Once the mating member 180 is received by the recess 176 of the fill neck 110, the mating member 180 and the recess 176 can cooperate to mitigate relative motion of the tubular insert 140 and the fill neck 110. In one example, the tubular insert 140, the fill neck 110, or both can be configured to deflect while the tubular insert 140 is being installed. In an alternative example, as illustrated in FIG. 6, the mating member 180 can be provided on a cutout 184 of the tubular insert 140 that can be configured to articulate during installation.

Referring collectively to FIGS. 1, 3, and 4, the tubular insert 140 can include a vent passage 186 that can be configured to allow fluid communication between the ullage space of a storage tank 100 and the passageway 146. Specifically, when the fluid fills the storage tank 100 to the fill amount 162, the ullage space can occupy the interior volume 104 that is unoccupied by fluid, e.g., the interior volume 104 between the fill amount 162 and the wall 102. In one example, the vent passage 186 can be positioned along the tubular insert 140 such that the vent passage is located within the second portion 122 of the fill neck 110.

Referring again to FIG. 3, the storage tank 100 can be used to store fuel such as, for example, marine fuel. For example, the cap 118 can be secured to the fill neck 110 to substantially close the storage tank 100. Accordingly, when the storage tank 100 is closed, fuel and fuel vapor can be substantially prevented from escaping into the atmosphere surrounding the storage tank 100. Additionally, the fill neck 110 can provide a sealing surface for the cap 118 and can substantially prevent permeation between a fill neck 110 and the nozzle bounding member 130.

Referring again to FIG. 1, the storage tank 100 can be opened. For example, the cap 118 can be removed from the fill neck 110. The interior volume 104 of the storage tank 100 can be exposed to the atmosphere via the fill neck 110. Accordingly, the interior volume 104 of the storage tank 100 can be vented to the atmosphere through the passageway 146 of the tubular insert 140. Additionally, the ullage space of the interior volume 104 of the storage tank 100 can be vented through the vent passage 186, which can permit the transfer of fuel vapor between the ullage space and the passageway 146 of the tubular insert 140.

The nozzle 20 can be inserted into the passageway 146. The stop 136 can contact the dispensing end 22 of the nozzle 20 to align the aspirator 24 with the cage 160 of the tubular insert 140. Accordingly, the aspirator 24 can be exposed to the interior volume 104 of the storage tank 100. The nozzle 20 can be actuated to dispense fuel out of the dispensing end 22 of the nozzle 20 and through the stop 136. When the fuel reaches the fill amount 162, which can be configured to be aligned with the aspirator 24 when the dispensing end 22 of the nozzle 20 contacts the stop 136, the automatic shutoff of the nozzle 20 can automatically terminate the dispensing of fuel. The fill amount 162 can be selected to maintain a required amount of ullage. For example, the ullage can be configured to allow venting and prevent spilling as the fuel expands due to heating and as required by EPA regulations and/or American Boat and Yacht Council (ABYC) standards. Alternatively or additionally, the system 10 can include a tube that can be inserted at the fill amount to retain the ullage space, when overfilled using a nozzle with no automatic shutoff function or overfilled with a jerry can.

It is noted that the terms “substantially” and “about” are utilized herein to represent an inherent degree of uncertainty that can be attributed to any quantitative comparison, value, measurement, or other representation. These terms are also utilized herein to represent the degree by which a quantitative representation may vary from a stated reference without resulting in a change in the basic function of the subject matter at issue.

Every quantitative range described herein should be understood to include every narrower quantitative range that is bounded by the described quantitative range herein, as if each narrower quantitative range was expressly described. For example, a quantitative range of “at least about 50%” should be read as to include a narrower range between (and inclusive of) the minimum value of 50% and the maximum value of 100%; e.g., all ranges beginning with a minimum value of 50% or more and ending with a maximum value of 100%; or less, e.g., 55% to 95%, 60% to 90%, 58% to 92%, etc.

While particular examples have been illustrated and described herein, it should be understood that various other changes and modifications may be made without departing from a spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system comprising:
a tank comprising a wall that bounds an interior volume of the tank and a fill neck that extends away from the wall and forms an opening of the tank; and
a nozzle bounding member coupled to the tank, wherein the nozzle bounding member comprises a stop aligned with the opening of the fill neck and configured to obstruct the motion of a nozzle, when the nozzle is inserted into the fill neck of the tank.

2. The system of claim 1,
wherein the fill neck comprises a first portion that forms an opening of the tank and a second portion adjacent to the wall of the tank; and
wherein the second portion has a larger cross section area than the first portion.

3. The system of claim 2, wherein the nozzle bounding member is provided as a tubular insert.

4. The system of claim 3,
wherein the tubular insert is coupled to a first cylindrical portion of the fill neck;
wherein the tubular insert define a passageway that extends from a first end of the tubular insert to a second end of the tubular insert; and
wherein the second end of the tubular insert is positioned within the interior volume of the tank and offset from the wall.

5. The system of claim 4, wherein the tubular insert comprises one or more locating slats positioned at the second end of the tubular insert and an orifice formed through the tubular insert, the orifice being positioned between the one or more locating slats and the wall of the tank.

6. The system of claim 5, wherein the tubular insert comprises a cage configured to expose an aspirator of the nozzle to the interior volume of the tank, the cage being positioned relative to the second end of the tubular insert and defining the orifice corresponding to one or more orifices.

7. The system of claim 3, wherein the tubular insert comprises a nozzle retention flange configured to limit a motion of the nozzle when the nozzle is inserted into the tank, the nozzle retention flange being positioned at the first end of the tubular insert.

8. The system of claim 7, wherein the nozzle retention flange is configured to interact with a retaining spring of the nozzle to limit the motion of the nozzle when the nozzle is inserted into the tank.

9. The system of claim 3,
wherein the fill neck comprises a rib formed with an interior surface of a first portion of the fill neck, the rib being shaped to interact with an outerflange of the tubular insert such that the fill neck and the tubular insert form an interference fit there between; and
wherein the fill neck further comprises a recess formed with the interior surface of the first portion of the fill neck, the recess being shaped to interact with a graduated detent of the tubular insert.

10. The system of claim 9, wherein the graduated detent of the tubular insert comprises a mating member shaped to the recess of the fill neck and a ramp portion that gradually increases a cross sectional area of an exterior surface of the tubular insert as the ramp portion extends toward the mating member along the tubular insert.

11. The system of claim 3, wherein the tubular insert further comprises a vent passage configured to allow fluid communication between a ullage space of the storage tank and the passageway.

12. The system of claim 1, wherein the fill neck comprises a nozzle retention flange and is configured to limit a motion of the nozzle when the nozzle is inserted into the storage tank.

13. A system comprising:
a tank comprising a wall that bounds an interior volume of the tank and a fill neck that extends away from the wall and forms an opening of the tank; and
a tubular insert provided in the fill neck, the tubular insert forms a passageway that extends from a first end of the tubular insert to a second end of the tubular insert, the second end of the tubular insert being positioned within the interior volume of the tank and offset from the wall,
wherein the tubular insert comprising one or more locating slats positioned at the second end of the tubular insert, and an orifice formed through the tubular insert, the orifice being positioned between the one or more locating slats and the wall of the tank, the one or more slats being configured to obstruct a motion of a nozzle, when the nozzle is inserted into the fill neck.

14. The system of claim 13,
wherein the fill neck comprises a first portion that forms an opening of the tank and a second portion adjacent to the wall of the tank; and
wherein the second portion has a larger cross section area than the first portion.

15. The system of claim 14, wherein the tubular insert comprises a cage configured to expose an aspirator of the nozzle to the interior volume of the storage tank, the cage being positioned relative to the second end of the tubular insert and defining the orifice corresponding to one or more orifices.

16. The system of claim 13,
wherein the tubular insert comprises a nozzle retention flange configured to limit a motion of the nozzle when the nozzle is inserted into the storage tank, the nozzle retention flange being positioned at the first end of the tubular insert; and
wherein the nozzle retention flange is configured to interact with a retaining spring of the nozzle to limit the motion of the nozzle when the nozzle is inserted into the tank.

17. The system of claim 13,
wherein the fill neck comprises a rib formed with an interior surface of a first portion of the fill neck, the rib being shaped to interact with an outer flange of the tubular insert such that the fill neck and the tubular insert form an interference fit there between; and
wherein the fill neck further comprises a recess formed with the interior surface of the first portion of the fill neck, the recess being shaped to interact with a graduated detent of the tubular insert.

18. The system of claim 17, wherein the graduated detent of the tubular insert comprises a mating member shaped to the recess of the fill neck and a ramp portion that gradually increases a cross sectional area of an exterior surface of the tubular insert as the ramp portion extends toward the mating member along the tubular insert.

19. A system comprising:
a tank comprising a wall that bounds an interior volume of the tank and a fill neck that extends away from the wall, wherein the fill neck comprises a first portion that forms an opening of the tank and a second portion adjacent to the wall of the tank, the second portion has a larger cross section area than the first portion;
a tubular insert coupled to the first portion of the fill neck,
wherein the tubular insert forms a passageway that extends from a first end of the tubular insert to a second end of the tubular insert, the second end of the tubular insert being positioned within the interior volume of the tank and offset from the wall, and
wherein the tubular insert comprises one or more locating slats positioned at the second end of the tubular insert, the one or more slats being configured to obstruct a motion of a nozzle, when the nozzle is inserted into the fill neck.

20. The system of claim 19,
wherein the tubular insert further comprises:
an orifice formed through the tubular insert, the orifice being positioned between the one or more locating slats and the wall of the tank; and
a nozzle retention flange configured to limit a motion of the nozzle when the nozzle is inserted into the tank, the nozzle retention flange being positioned at the first end of the tubular insert.
